(19) United States
(12) Patent Application Publication
(10) Pub. No.: US 2017/0076293 A1
(43) Pub. Date: Mar. 16, 2017

(54) CREATING, VERIFICATION, AND INTEGRATION OF A DIGITAL IDENTIFICATION ON A MOBILE DEVICE

(71) Applicant: LINQ3 TECHNOLOGIES LLC, New York, NY (US)

(72) Inventors: Daniel Cage, Atlanta, GA (US); Padmakar Kankipati, Marietta, GA (US); Randall E. Lex, Sugar Hill, GA (US)

(73) Assignee: LINQ3 TECHNOLOGIES LLC, New York, NY (US)

(21) Appl. No.: 14/856,421

(22) Filed: Sep. 16, 2015

(51) Int. Cl. G06Q 20/40; G06Q 20/32; H04L 29/06

(52) U.S. Cl. CPC G06Q 20/40145; H04L 63/10; G06Q 20/3223

(57) ABSTRACT

Described herein are apparatuses, methods, and computer readable media for verifying access of an instance of a digital identification on a mobile device. An exemplary method comprises establishing a first communication channel from a mobile device to a data transformation system; receiving an authentication credential on the first communication channel; verifying the authentication credential; and providing access to the instance of the digital identification. In response to verifying the authentication credential, the mobile device accesses: the instance of the digital identification, an indicator associated with the instance of the digital identification indicating the instance of the digital identification is verified, a countdown timer indicating an amount of time remaining for accessing the instance of the digital identification, and a readable indicia associated with accessing the instance of the digital identification.

### TECHNICAL FIELD

The present application generally relates to a digital identification.

### BACKGROUND

A physical personal identification card is used to verify the identity of a user in various places outside a user's home (e.g., when making a purchase, when checking-in at an airport, when interacting with a law enforcement officer, etc.). Sometimes a user may forget to carry the physical personal identification card when leaving the user's home. Other times, the user may find it a burden to carry the physical personal identification card because the user may need to carry a wallet or a purse to hold the physical personal identification card. Therefore, there exists a need to make it less burdensome for a user to carry a personal identification card. Smartphones are ubiquitous these days, and a user will almost never forget to carry a smartphone when leaving the user's home. Therefore, a smartphone could be used to solve the issues associated with carrying around a physical personal identification card.

### SUMMARY

Described herein are various implementations of methods, apparatuses, and computer readable media for creating, verifying, and integrating digital identification on a mobile device. In some embodiments, a method is provided for verifying access of an instance of a digital identification. The method comprises establishing a first communication channel from a mobile device to a data transformation system; receiving an authentication credential on the first communication channel; verifying the authentication credential; and providing access to the instance of the digital identification, wherein, in response to verifying the authentication credential, the mobile device accesses: the instance of the digital identification, an indicator associated with the instance of the digital identification indicating the instance of the digital identification is verified based on communication with a database system, a countdown timer indicating an amount of time remaining for accessing the instance of the digital identification, and a readable indicia associated with the accessing the instance of the digital identification.

In some embodiments, the method further comprises in response to verifying the authentication credential, generating a verification request; establishing a second communication channel from the data transformation system to the database system; and verifying the verification request based on communicating with the database system.

In some embodiments, the verification request comprises user information stored in the data transformation system.

In some embodiments, the verification request comprises verification data generated by the data transformation system.

In some embodiments, verifying the verification request comprises determining whether user information comprised in the verification request matches user information comprised in a user record in the database system.

In some embodiments, the authentication credential and the verification request are verified in real-time.

In some embodiments, the authentication credential comprises device authentication data associated with the mobile device and user authentication data associated with a user of the mobile device.

In some embodiments, the user authentication data comprises biometric data associated with the user.

In some embodiments, a method is provided for accessing an instance of a digital identification. The method comprises establishing a first communication channel from a mobile device to a data transformation system; transmitting, from the mobile device, an authentication credential via the first communication channel; accessing, by the mobile device, the instance of the digital identification via the first communication channel; presenting, by the mobile device, the instance of the digital identification; presenting, by the mobile device, an indicator associated with the instance of the digital indication indicating whether the instance of the digital identification is verified; presenting, by the mobile device, a countdown timer indicating an amount of time remaining for accessing the instance of the digital identification; and presenting, by the mobile device, a readable indicia associated with the instance of the digital identification.

In some embodiments, the method further comprises locking a display of the mobile device, the locking the display of the mobile device disabling manipulation of the instance of the digital identification.

In some embodiments, the method further comprises presenting an airline ticket or boarding pass integrated with the instance of the digital identification.

In some embodiments, the method further comprises presenting a history of access instances of the digital identification.

In some embodiments, the method further comprises associating the digital identification with a payment card associated with a mobile wallet or a payment transaction executed on the mobile device.

In some embodiments, a method is provided for registering a digital identification. The method comprises establishing a first communication channel from a mobile device to a data transformation system; receiving, at the data transformation system, on the first communication channel, an authentication credential, information associated with an identification of a user of the mobile device, and an image of the user of the mobile device; establishing a second communication channel from the data transformation system to a database system; comparing at least one of the authentication credential, the information associated with the identification of the user of the mobile device, or the image of the user to information comprised in the database system; and in response to determining a match between at least one of the authentication credential, the information associated with the identification of the user of the mobile device, or the image of the user to the information comprised in a database, creating the digital identification for the user.

In some embodiments, establishing the second communication channel comprises searching, at the database system, for a user record associated with the user of the mobile device, and wherein the information comprised in the database system comprises the user record.

In some embodiments, establishing the second communication channel comprises receiving the information comprised in the database system.

In some embodiments, the authentication credential comprises device authentication data associated with the mobile device or user authentication data associated with the user.

In some embodiments, the authentication credential comprises a credential previously transmitted from the data transformation system to the user.

In some embodiments, the digital identification is accessible on the mobile device, and is inaccessible on a different mobile device.

In some embodiments, a method is provided for associating a mobile device with a user. The method comprises establishing a first communication channel from a first mobile device to a data transformation system; receiving an authentication credential on the first communication channel, the authentication credential being associated with a user of the second mobile device; verifying the authentication credential; transmitting, on the first communication channel, a token to the first mobile device; verifying the first mobile device based on determining input of the token on the first mobile device; associating the first mobile device with the user; and disassociating the second mobile device from the user.

In some embodiments, a method is provided for verifying a digital identification presented on a mobile device. The method comprises establishing a first communication channel from a first mobile device to a second mobile device; scanning, using the first mobile device, a readable indicia presented on the second mobile device, the readable indicia being presented using a digital identification application, the readable indicia being associated with user data associated with a user of the second mobile device; establishing a second communication channel from the first mobile device to a data transformation system; transmitting the readable indicia to the data transformation system, wherein the data transformation system verifies the user data based on matching the user data with data associated with a user record accessed from a database system in communication with the data transformation system; and receiving, using the second mobile device, an indicator from the data transformation system indicating the user data is verified.

In some embodiments, an apparatus is provided for creating, verifying, and integrating digital identification on a mobile device. The apparatus comprises an I/O module; a communication unit; a memory; and processor, coupled to the I/O module, the communication unit, and the memory, and configured to perform the various methods described herein.

In some implementations, a non-transitory computer readable medium is provided for creating, verifying, and integrating digital identification on a mobile device. The non-transitory computer readable medium comprises computer executable code configured to perform the various methods described herein.

### BRIEF DESCRIPTION OF THE DRAWINGS

Reference is now made to the following detailed description, taken in conjunction with the accompanying drawings. It is emphasized that various features may not be drawn to scale and the dimensions of various features may be arbitrarily increased or reduced for clarity of discussion. Further, some components may be omitted in certain figures for clarity of discussion.

FIG. 1 shows a diagram for registering a user, in accordance with some embodiments of the disclosure;

FIG. 2 shows a diagram for obtaining user data by a mobile device, in accordance with some embodiments of the disclosure;

FIG. 3 shows another diagram for registering a user, in accordance with some embodiments of the disclosure;

FIG. 4 shows a diagram for verifying a user's identity, in accordance with some embodiments of the disclosure;

FIG. 5 shows a diagram illustrating components of a digital identification, in accordance with some embodiments of the disclosure;

FIG. 6 shows user interfaces for accessing the digital identification application on a mobile device, in accordance with some embodiments of the disclosure;

FIG. 7 shows user interfaces for integrating the digital identification into electronic airline boarding passes or tickets, in accordance with some embodiments of the disclosure;

FIG. 8 shows a diagram of the communication between a system and a database, in accordance with some embodiments of the disclosure;

FIG. 9 shows a diagram associated with accessing a previously registered digital identification on a different mobile device from the mobile device associated with the registered digital identification, in accordance with some embodiments of the disclosure;

FIG. 10 shows a method for registering a digital identification, in accordance with some embodiments of the disclosure;

FIG. 11 shows a method for using a digital identification application, in accordance with some embodiments of the disclosure;

FIG. 12 shows a method for verification of the digital identification by a data checker, in accordance with some embodiments of the disclosure;

FIG. 13 shows another method for verification of the digital identification by a data checker, in accordance with some embodiments of the disclosure;

FIG. 14 shows a method for displaying a history of access instances associated with the digital identification, in accordance with some embodiments of the disclosure;

FIG. 15 shows a method for displaying settings associated with the digital identification application, in accordance with some embodiments of the disclosure;

FIG. 16 shows a method for managing a payment card associated with a mobile wallet, in accordance with some embodiments of the disclosure;

FIG. 17 shows a method for providing access to an instance of a digital identification, in accordance with some embodiments of the disclosure;

FIG. 18 shows a method for presenting an instance of a digital identification on a mobile device, in accordance with some embodiments of the disclosure;

FIG. 19 shows a method for creating a digital identification for a user, in accordance with some embodiments of the disclosure;

FIG. 20 shows a method for associating a new mobile device with a digital identification, in accordance with some embodiments of the disclosure; and

FIG. 21 shows a method for using a first mobile device to determine whether a digital identification presented on a second mobile device is verified, in accordance with some embodiments of the disclosure.

Although similar reference numbers may be used to refer to similar elements for convenience, it can be appreciated that each of the various example implementations may be considered distinct variations.

### DETAILED DESCRIPTION

Embodiments of the present disclosure are directed to accessing, on a mobile device, a digital identification associated with a user of the mobile device. The present disclosure provides a technological solution to the age-old problems associated with carrying or forgetting to carry physical identification cards. The digital identification may be associated with a single mobile device of the user, is accessible on the mobile device based on verifying user data associated with the user and/or device data associated with the mobile device, and presents, in real-time, up-to-the-second information pulled from a database (e.g., a public database) where information associated with the user's identification is held. The digital identification is not stored on the mobile device and therefore the digital identification cannot be comprised even if the mobile device is lost or stolen. The digital identification may be used as a digital driver's license, and may be presented in either portrait or landscape orientation on the mobile device. Any of the methods described herein may performed in real-time. Any of the features described with respect to one of the figures may be applicable to one of the other figures. As used herein validation and verification may refer to the same procedure, and may be used interchangeably.

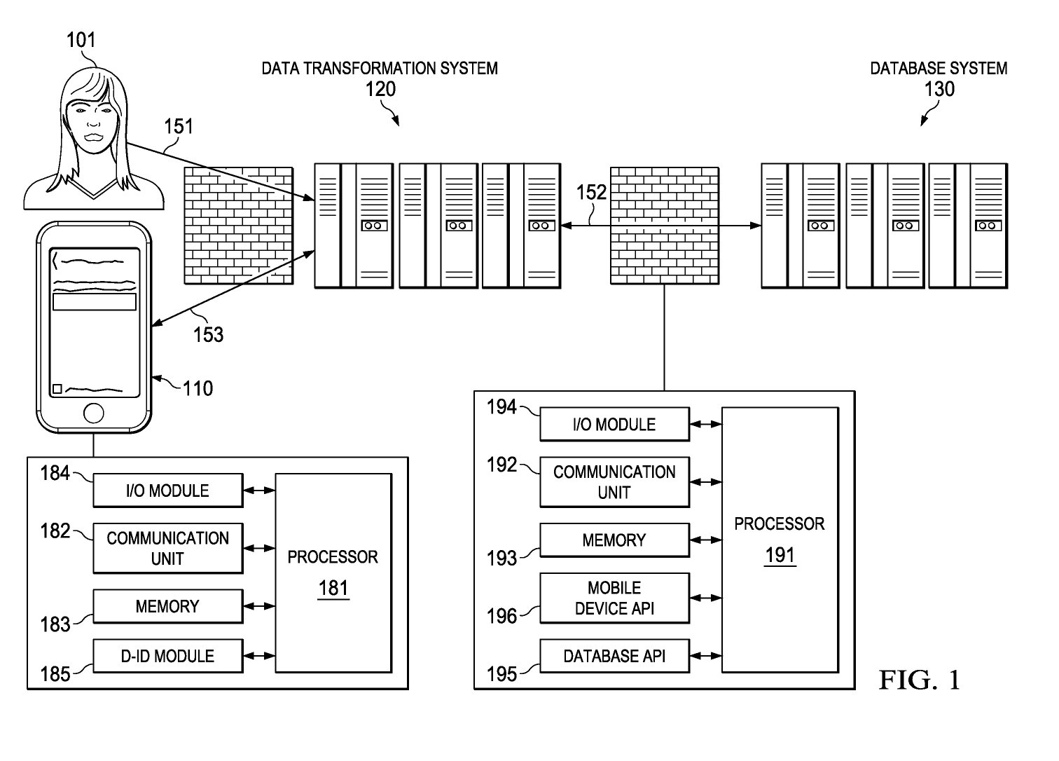

FIG. 1 shows a block diagram for registering a user. The registration procedure is executed when a user 101 wishes to create a digital identification on a mobile device 110 for the first time. At block 151, the user transmits a registration request to a data transformation system 120 indicating the user's desire to register for a digital identification. In some embodiments, the data transformation system 120 may also be referred to as a data creation system, a data integration system, a data processing system, etc. The system 120 accesses 152 (e.g., in real-time) or communicates with a database 130 to determine whether to register the digital identification for the user. The system 120 may be managed by a private entity. The database 130 may be managed by a different entity (e.g., a public entity or a private entity) compared to the system 120. Once the user 101 is registered, the mobile device 110 may be verified 153 by the system 120 in communication with the database 130 for subsequent accesses of the digital identification. The system 120 may transform data from one form (e.g., a mobile device communication protocol) to another form (e.g., a database communication protocol), and vice versa, to enable the system 120 to communicate with the both the mobile device 110 and the database 130.

The system 120 includes a processor 191, a communication unit 192, a memory 193, an I/O module 194, a mobile device API 196, and a database API 195. The processor 191 may control any of the other modules and/or functions performed by the various modules in the system 120. Any actions described as being taken by a processor may be taken by the processor 191 alone or by the processor 191 in conjunction with one or more additional modules. Additionally, while only one processor may be shown, multiple processors may be present. Thus, while instructions may be described as being executed by the processor 191, the instructions may be executed simultaneously, serially, or otherwise by one or multiple processors. The processor 191 may be implemented as one or more CPU chips and may be a hardware device capable of executing computer instructions. The processor 191 may execute instructions, codes, computer programs, or scripts. The instructions, codes, computer programs, or scripts may be received from memory 193, from the I/O module 194, or from communication unit 192.

Communication unit 192 may include one or more radio transceivers, chips, analog front end (AFE) units, antennas, processing units, memory, other logic, and/or other components to implement communication protocols (wired or wireless) and related functionality for communicating with the mobile device 110 and the database 130. As a further example, communication unit 192 may include modems, modem banks, Ethernet devices, universal serial bus (USB) interface devices, serial interfaces, token ring devices, fiber distributed data interface (FDDI) devices, wireless local area network (WLAN) devices or device components, radio transceiver devices such as code division multiple access (CDMA) devices, global system for mobile communications (GSM) radio transceiver devices, universal mobile telecommunications system (UMTS) radio transceiver devices, long term evolution (LTE) radio transceiver devices, worldwide interoperability for microwave access (WiMAX) devices, and/or other devices for communication. Communication protocols may include WiFi, Bluetooth®, WiMAX, Ethernet, powerline communication (PLC), etc. I/O module 194 may include liquid crystal displays (LCDs), touch screen displays, keyboards, keypads, switches, dials, mice, track balls, voice recognizers, card readers, paper tape readers, printers, video monitors, or other input/output devices.

Memory 193 may include random access memory (RAM), read only memory (ROM), or various forms of secondary storage. RAM may be used to store volatile data and/or to store instructions that may be executed by the processor 191. For example, the data stored may be a command, a current operating state of the system 120, an intended operating state of the system 120, etc. As a further example, the data stored may be instructions related to the various methods described herein. ROM may be a non-volatile memory device that may have a smaller memory capacity than the memory capacity of a secondary storage. ROM may be used to store instructions and/or data that may be read during execution of computer instructions. Access to both RAM and ROM may be faster than access to secondary storage. Secondary storage may be comprised of one or more disk drives or tape drives and may be used for non-volatile storage of data or as an over-flow data storage device if RAM is not large enough to hold all working data. Secondary storage may be used to store programs that may be loaded into RAM when such programs are selected for execution. In some embodiments, the memory 193 may comprise a database comprising user records. In some embodiments, the memory 193 may store the user data described herein. In some embodiments, the memory 193 may store the digital identifications associated with registered users described herein. Additionally or alternatively, the database comprising user records may be a secondary database that is located remotely from the system 120. The secondary database may be managed by a retailer, an airline, a financial institution, or the like.

In some embodiments, the system 120 provides separate application programming interfaces (APIs) for communicating with the mobile device 110 and the database 130. A mobile device API 196 may provide a connection for communicating with the mobile device 110. A database API 195 may provide a connection for communicating with the database 130. Each API shown in FIG. 1 may be associated with a customized physical circuit. The system 120 may not be a generic computing system, but may be a customized computing system designed to perform the various methods described herein. The walls in the various figures may represent firewalls.

The mobile device 110 may also comprise a processor 181 coupled to an I/O module 184, a communication unit 182, a memory 183, and a digital identification (DID) module 185. The processor 181 may have features similar to the processor 191. The I/O module 184 may have features similar to the I/O module 194. The I/O module 184 may be capable of accepting biometric input. The communication unit 182 may have features similar to the communication unit 192. The memory 183 may have features similar to the memory 193. The DID module may be a customized physical circuit that enables acceptance of digital identification authentication credentials and enables communication with the system 120. The mobile device 110 may not be a generic computing system, but may be a customized computing system designed to perform the various methods described herein.

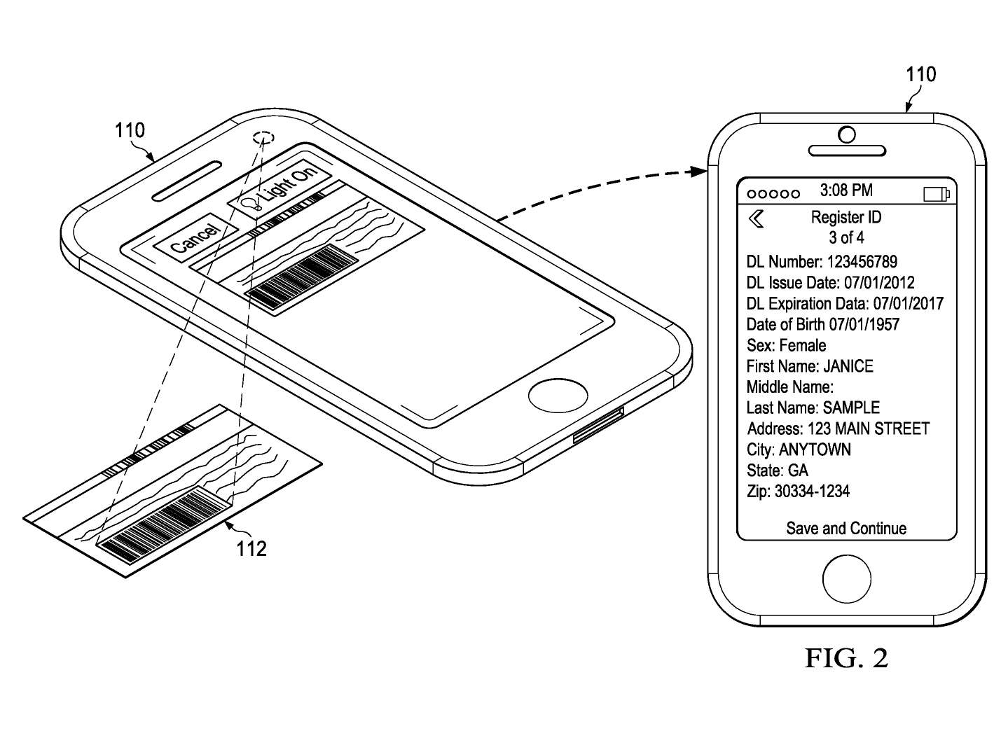

FIG. 2 shows a diagram for obtaining user data by the mobile device 110. The mobile device 110 may receive information from readable indicia located on the user's physical identification card. For example, if the physical identification card includes a code, the user scans the code using the mobile device 110. A code may refer to any kind of code, and is not limited to a barcode. The code may represent any form of readable indicia. For example, the code may represent an active or passive near field communication (NFC) chip located on the physical identification card. In other embodiments, the code may be a Quick Response (QR) code. In an example, the physical identification card may be a driver's license. The user data received by the mobile device 110 includes the identification card number, the identification card issue date, the identification card expiry date, the user's date of birth, the user's gender, the user's first name, middle name, and last name, the user's address, including city, state, and zip code, etc.

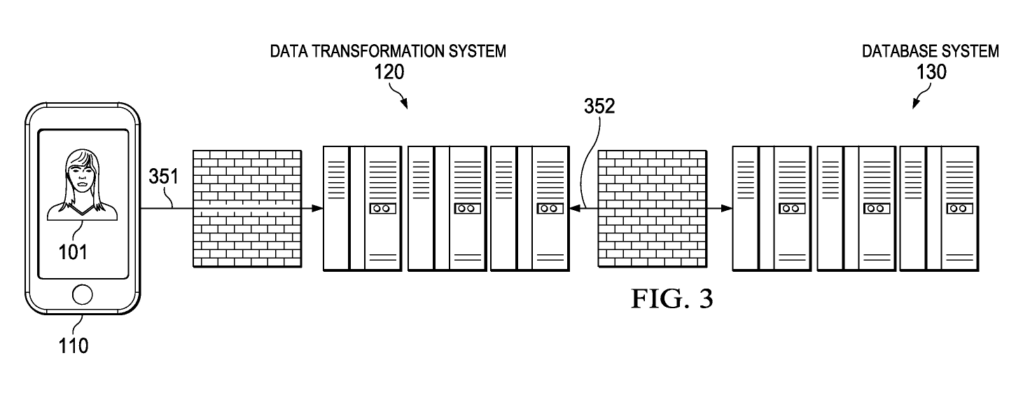

FIG. 3 shows another block diagram for registering a user 101. The user 101 captures a photo of the user's face using the mobile device 110. Alternatively, the user 101 may capture a photo of other body parts or distinguishing body features of the user 101. Still alternatively, the user 101 may select a previously captured photo, wherein the photo was captured by the mobile device 110 or captured by a different image-capturing device. The photo may be transmitted 351 to the data transformation system 120 along with the user data obtained in FIG. 2. The system 120 accesses 352 the database 130, scans the database 130 records based on or more parts of the user data or the photo, locates a record associated with the user 101, and compares at least one of the photo or the user data with a photo or user data associated with the record. The comparison may be performed at the system 120. If there is a match between the photo or the user data received from the mobile device 110 and the photo or the user data accessed from the database 130, a digital identification is registered for the user 101. The system 120 may transmit a message to the mobile device 110 indicating that the user's digital identification has been successfully registered. The digital identification may be stored at the system 120, a database associated with the system 120, or at a secondary database as described herein. Portions (e.g., user data, photo etc.) of the digital identification may be stored separately, such that the portions may be dynamically combined (e.g., at the system 120 or the mobile device 110) upon receiving a request from the mobile device 110 to access the digital identification. The digital identification may not be stored at the mobile device 110. The digital identification may be shared, either directly or indirectly, among the mobile device 110, the system 120, and the database 130.

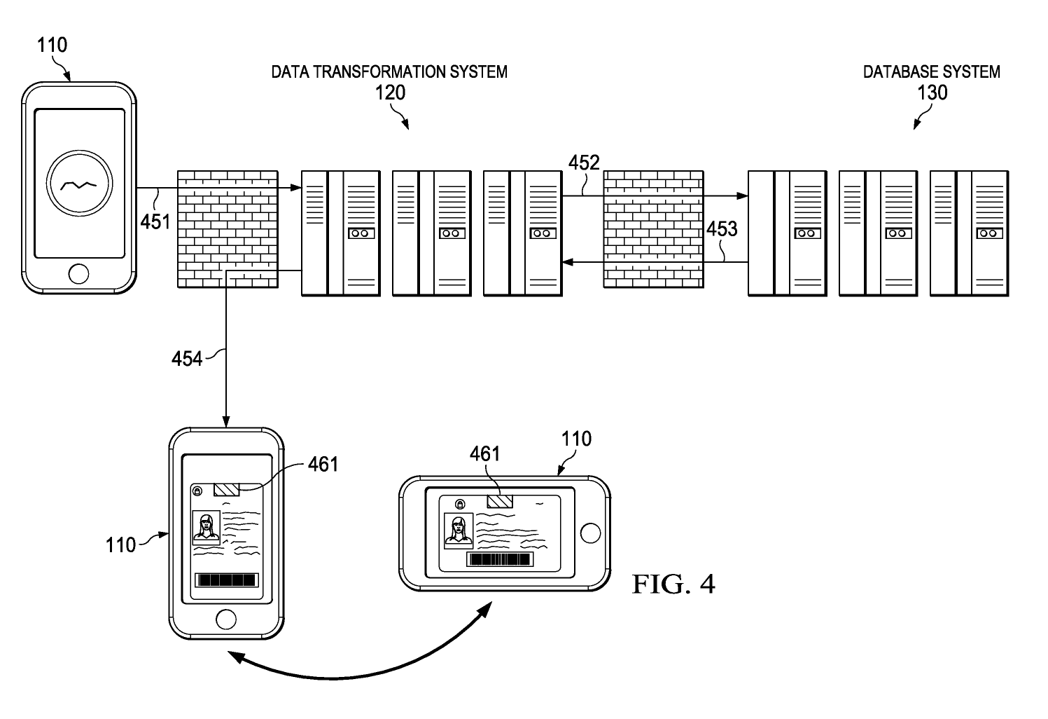

FIG. 4 shows a block diagram for verifying a user's identity using the digital identification accessed on the mobile device 110. A user may access a digital identification application on the mobile device 110. Upon accessing the application, and selecting an option to view the digital identification (e.g., after entering an authentication credential), an authentication request comprising the authentication credential is transmitted 451 from the mobile device 110 to the system 120. The authentication credential may comprise at least one of user authentication data or device authentication data. User authentication data includes text input (e.g., a password, a password or PIN number previously communicated from the system 120 to the mobile device 110 or another communication destination associated with the user (e.g., an email address), biometric input, photo input, etc.). Device authentication data includes one or more data pieces associated with the device. Device authentication data includes a mobile equipment identifier (MEID) and/or a carrier associated with the mobile device 110.

The system 120 may verify the authentication request (e.g., the device data and/or the user data) by determining whether the authentication credential is valid. The authentication credential may be compared to data (e.g., an authentication credential) stored at the system 120 or a database associated with the system 120 to determine whether there is a match. The data may have been stored at the system 120 at the time of registering the user. Alternatively or additionally, the system 120 may perform a computation on the authentication credential to determine whether it is valid. Upon determining the authentication credential is valid, the system 120 accesses a user record associated with the authentication credential. The user record may comprise user data (e.g., identification number, name, date of birth, etc.) stored in the system 120 when the user was registered for a digital identification. In some embodiments, the authentication request may be validated by the mobile device 110, additionally or alternatively to the system 120. For example, biometric data may be stored in the mobile device's encrypted storage and may be compared to the input biometric data to determine whether there is a match.

The system 120 may generate a verification request (e.g., comprising the user data) and communicate 452 with the database 130 to verify the request. The system 120 accesses 452, 453 the database 130 and accesses a user record associated with the user. The user record at the database 130 may be accessed by searching through the database 130 using one or more parts of the user data stored in the system 120. The system 120 then compares the user data stored in the system 120 to data associated with the user record accessed from the database 130. If there is a match between the two sets of data, the verification request is verified, and the digital identification is transmitted 454 to the mobile device 110 from the system 120. In some embodiments, the user data for the digital identification is transmitted 454 to the mobile device 110, and the mobile device 110 constructs the graphical representation of the digital identification based on the received data. In other embodiments, the system 120 transmits 454 the graphical representation of the digital identification to the mobile device 110. The digital identification comprises an indicator 461 with a status indicating that the access of the digital identification is a verified access. For example, the indicator 461 is colored in green to indicate that the access is a verified access. Verified access means that that there is a match between the user data stored in the system 120 and the user data associated with the user record accessed from the database 130. In other embodiments, verified access also refers to the digital identification application being executed on the mobile device 110 is a verified authenticated copy of the digital identification application. This determination may also be made by the system 120 based on application-specific data being transmitted from the mobile device 110 to the system 120 in or along with the authentication credential.

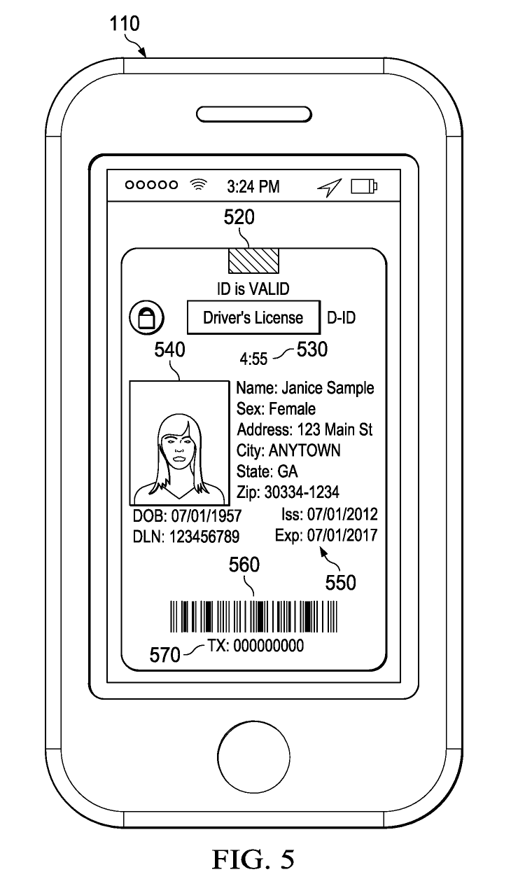

FIG. 5 shows a diagram illustrating components of the digital identification. Indicator 520 status shows the status of whether the digital identification accessed on the mobile device 110 is a verified (e.g., green indicator) or unverified (e.g., red indicator) access. This means that, in some embodiments, the digital identification may be accessed on the mobile device 110 even though there is no match between the user data stored in the system 120 and the user data associated with the user record accessed from the database 130. In embodiments where there is no match, the user data stored in the system 120 is presented on the digital identification presented on the mobile device 110. In alternate embodiments, where there is no exact match for all fields of the digital identification, only those fields that are matched are presented on the digital identification presented on the mobile device 110. Timer 530 is a countdown timer that shows the amount of time remaining before the user needs to be re-authenticated and/or the user data needs to be re-verified based on communication between the system 120 and the database 130. The photo 540 may be a photo associated with the digital identification. The photo 540 may be pulled from the database 130 during the registration of the digital identification. In other embodiments, the photo 540 may be received from a physical identification card or from a photo captured by, or otherwise accessed by, the mobile device 110. The digital identification includes a code 560 or readable indicia that may be transmitted to (e.g., scanned by) another device. The digital identification also includes a unique transaction number 570 for each instance of an access of the digital identification. In some embodiments, when the digital identification is presented on the display of the mobile device 110, the display of the mobile device 110 is locked in order to prevent a snooping attack designed to pull or otherwise compromise the digital identification information presented on the display.

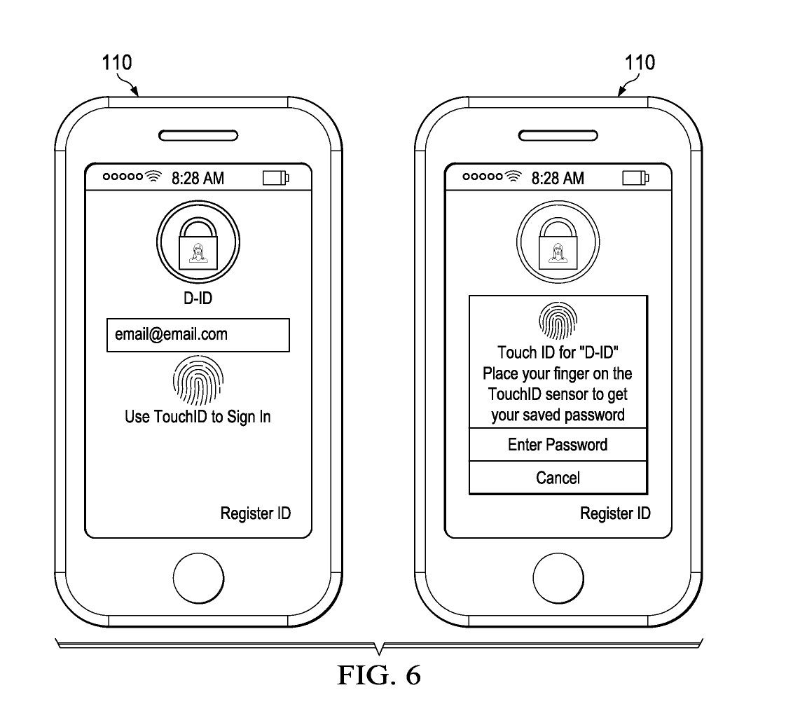

FIG. 6 shows user interfaces for accessing the digital identification application on a mobile device 110. In some embodiments, a user enters a previously registered email address and touches a biometric input device on the mobile device 110 for enabling the mobile device 110 to receive biometric information associated with the user's body part that touches the biometric input device.

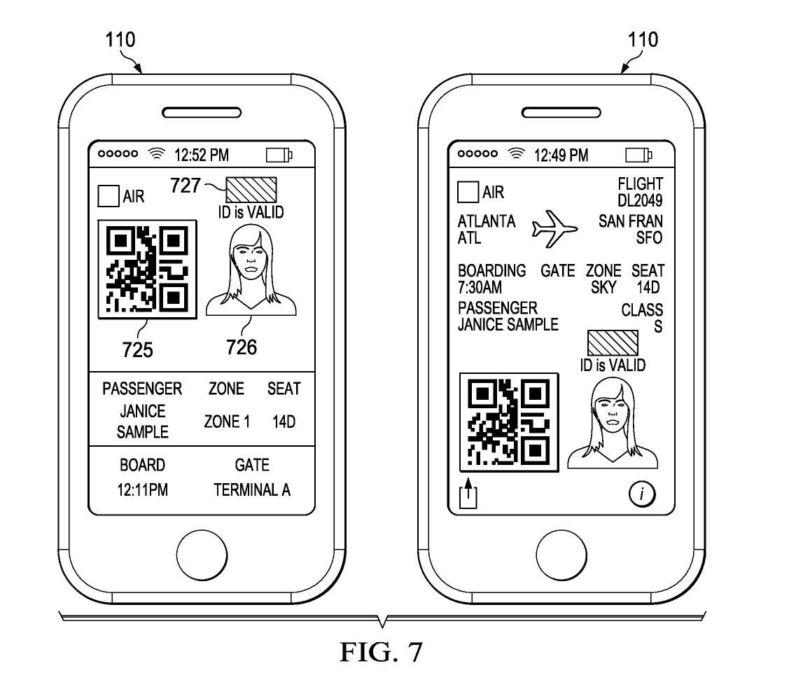

FIG. 7 shows user interfaces for integrating portions of the digital identification 726 into electronic airline boarding passes or tickets. An exemplary digital boarding pass presented on a mobile device 110 includes boarding pass code or digital identification code 725 and a digital identification 726. The digital identification 726 includes an indicator 727 indicating whether the integrated digital identification 726 is verified or not verified. The verified digital identification 126 may be used by gate agents or other data checkers to verify a traveler's identity. In some embodiments, the digital identification may be integrated into a mobile wallet application. Verification of the digital identification may be necessary to access one or more digital payment cards of the mobile wallet application.

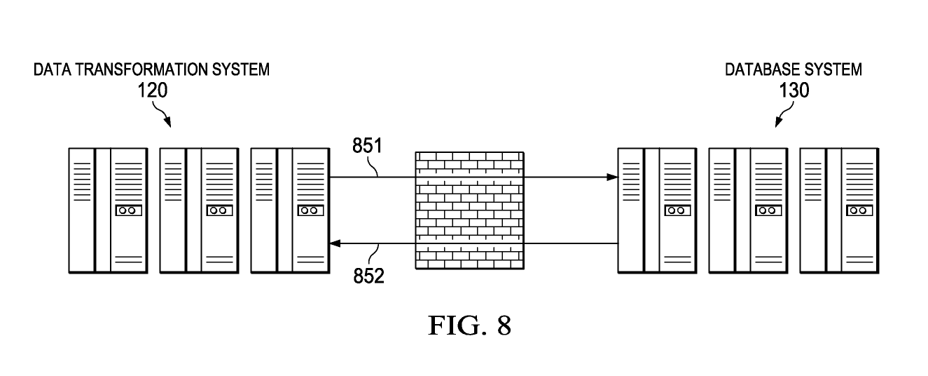

FIG. 8 shows a block diagram of the communication between the system 120 and the database 130. On a periodic (e.g., daily) basis, the system 120 determines users who have registered for a digital identification, and requests 851 user data for those users from the database 130. Upon receiving the system's request, the database 130 transmits 852 the user data to the system 120 or enables the system 120 to access the database records, search the database records using the user data, and pull 852 user data associated with registered users to the system 120. The system 120 may update user records stored in the system 120 or another database accessed by the system 120 based on the received data from the database 130. In an example, a user may have updated the user's registered address with the entity associated with the database 130. This updated address is transmitted 852 to the system 120 upon sending 851 a request to the database 130. When a user subsequently access the digital identification application on the mobile device 110, the address displayed on the digital identification is the updated address.

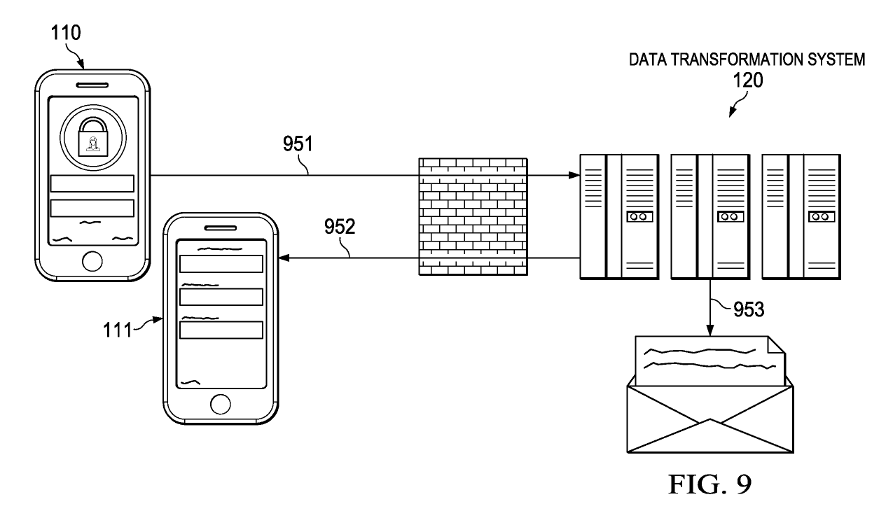

FIG. 9 shows a block diagram associated with accessing a previously registered digital identification on a second mobile device 111, wherein the digital identification was registered on a first mobile device 110. A user accesses the digital identification application on the second mobile device 111 (or the first mobile device 110 in some embodiments) and provides an authentication credential to authenticate to the digital identification application. The user may select a ‘change device’ option that is presented on the user interface of the digital identification application. A device change request is transmitted 951 from the second mobile device 111 (or the first mobile device 110 in some embodiments) to the system 120. The system 120 verifies the access of the digital identification application on the second mobile device 111, e.g., based on checking if the authentication credential is correct, sending 952 security questions to the second mobile device 111, and determining whether answers to those questions received from the second mobile device 111 are correct. Upon verifying the access of the digital identification application on the second mobile device 111, the system 120 may send 953 a unique token to a communication destination (e.g., email address, SMS, or other form of communication) associated with the registered user. The user receives the unique token and logs into the digital identification application on the second mobile device 111 using the token. The user is subsequently prompted on the digital identification application to confirm the user's registration of the second mobile device 111. The system 120, upon determining the user confirmed the user's registration of the new device, updates one or more user records with device data (e.g., device identification data) transmitted from the second mobile device 111 to the system 120. The system 120 may transmit a confirmation of the user's registration to the communication destination associated with the user. The system 120 disassociates itself from the first mobile device 110 and deletes any device data associated with the first mobile device 110 from a user record stored by the system 120. In some embodiments, the system 120 may even communicate with the first mobile device 110 to delete any digital identification application information stored in the first mobile device 110. A user will no longer be able to access the digital identification on the first mobile device 110.

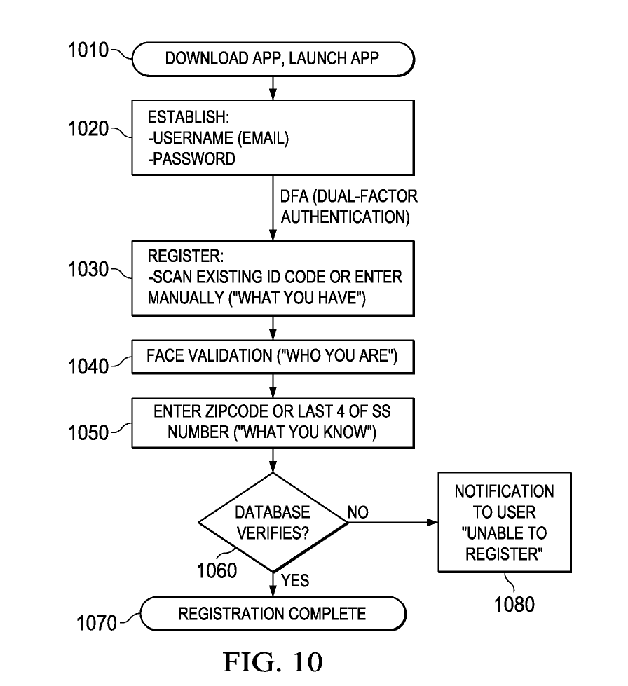

FIG. 10 shows a method for registering a digital identification. At block 1010, a digital identification application is downloaded onto a mobile device 110. Upon launching the digital identification application on the mobile device 110, the user selects an option to register a new digital identification. At block 1020, the user of the mobile device 110 inputs registration information, including a username (e.g., an email address or other contact information) and a password. The user may need to input the password at least two times. Additionally, the user may need to input a phone number. The user then subsequently selects an option to transmit the inputted information to the system 120. The system 120 may temporarily register the user based on the information received from the mobile device 110 and may transmit an authentication credential (e.g., a PIN number) to the user. The authentication credential may be transmitted to a communication destination associated with the user (e.g., an email to the user's email address, a text or multimedia message to the user's phone number, etc.). Once the authentication credential is received by the user on the mobile device 110 or on a different computing device, the user inputs the authentication credential on the digital identification application user interface. The inputted authentication credential may then be transmitted from the mobile device 110 to the system 120. The system 120 then verifies the authentication credential. If the authentication credential is verified by the system 120, the user is prompted to input information associated with the user's physical identification card. In some embodiments, the mobile device 110 may also send device authentication data as described herein to the system 120. In some embodiments, the device authentication data may be included in the authentication credential.

At block 1030, the user uses the mobile device 110 to scan a code associated with a physical identification card, or inputs information associated with the code manually into the mobile device 110. Alternatively, the user may capture a photo of the physical identification card or a photo of the readable indicia. The information associated with the physical identification card may be presented on the user interface of the mobile device 110. In some embodiments, the user may be able to modify this information, while in other embodiments, the user is unable to modify this information. The information may be transmitted to the system 120 or may be temporarily stored in the mobile device 110. At block 1040, the user uses the mobile device 110 to capture a photo associated with the user or access a previously captured photo associated with the user. At block 1050, the user enters a zip code or digits from the user's social security number on the user interface of the mobile device 110. The information in blocks 1030, 1040, and 1050 may be transmitted, either singly or in combination, to the system 120 described herein. The system 120 may verify 1060 the user based on comparing the information (e.g., the user's photo and or other user data) to information accessed from the database 130, and determining whether there is a match between the information received from the mobile device 110 and the information accessed from the database 130. If the information received from the mobile device 110 is verified (e.g., if there is a match), a digital identification is registered 1070 for the user, and the system 120 communicates to the mobile device 110 that the digital identification has been registered for the user. If the information received from the mobile device 110 is not verified 1080 (e.g., if there is no match), the system 120 transmits a message to the mobile device 110 indicating that the system 120 is unable to register the user. In some embodiments, if the information received from the mobile device 110 is verified, the user at the mobile device 110 is prompted to authorize the system 120 to use the information (e.g., photo and extracted information from the physical identification card) transmitted to the system 120 to create a digital identification for the user.

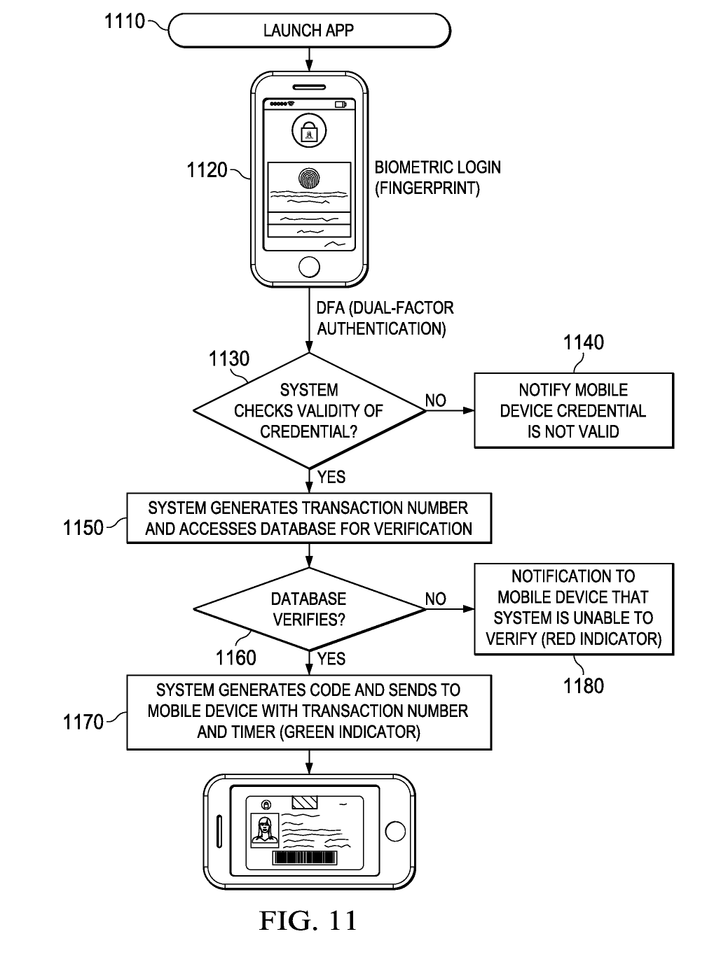

FIG. 11 shows a method for using a digital identification application. The user launches 1110 the digital identification application on the mobile device 110. The user inputs 1120 an authentication credential such as biometric information on a biometric input device of the mobile device 110. Additionally or alternatively, the user may input another authentication credential (e.g., a password) on the user interface of the mobile device 110. The authentication credential (e.g., biometric information or other verification information) is transmitted from the mobile device 110 to the system 120. The system 120 verifies 1130 the authentication credential based on various procedures described herein (e.g., procedure described in FIG. 4). If the authentication credential is not valid, the system 120 transmits 1140 a message to the mobile device 110 indicating the authentication credential is invalid.

If the authentication credential is valid, the system 120 generates a transaction number (e.g., a transaction identification number) and accesses the database 130 for verification of the user data comprised in a user record associated with the verified authentication credential. Upon verification 1170 of the request by the system 120 in communication with the database 130, the system 120 generates a dynamic code or other readable indicia (e.g., a barcode) and transmits the code to the mobile device 110 with a transaction number and a timer. When the digital identification is presented on the mobile device 110, the digital identification may include an indicator that indicates a status of the digital identification as verified. In some embodiments, the user data stored in the system 120 may not be able to be verified if the system 120 is unable to contact the database 130, or if there is a mismatch between the user data stored in the system 120 and data associated with the user record stored in the database 130. If the request cannot be verified, a message may be presented on the mobile device 110 indicating the request cannot be verified 1180. Alternatively or additionally, if the request cannot be verified, the digital identification may be presented on the mobile device 110 (e.g., using user data stored in the system 120) with an indicator that indicates a status of the digital identification as unverified. The digital identification may comprise the user data stored in the system 120.

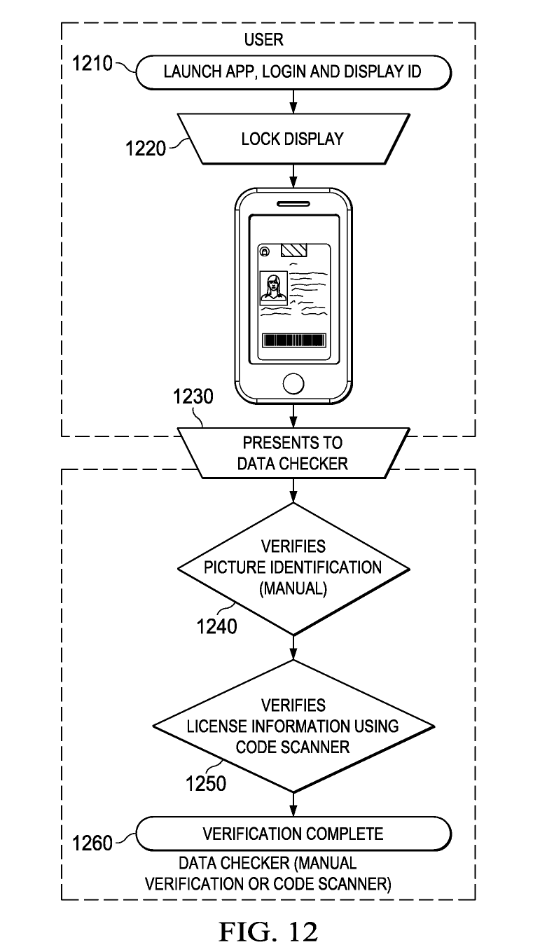

FIG. 12 shows a method for verification of the digital identification by a data checker. At block 1210, the method comprises launching the digital identification application on the mobile device 110. At block 1220, the user may select an option to lock the display of the mobile device 110, or the display of the mobile device 110 may be automatically locked upon presenting the digital identification. At block 1230, the user may present the digital identification to the data checker. At block 1240, the data checker may verify the photo in the digital identification by comparing with the user's face. Alternatively or additionally, the data checker may verify the digital identification by scanning 1250 the code on the digital identification using a scanner, and verifying 1260 the information associated with the digital identification by comparing to information accessed by the scanner, and determining whether there is a match between the sets of information.

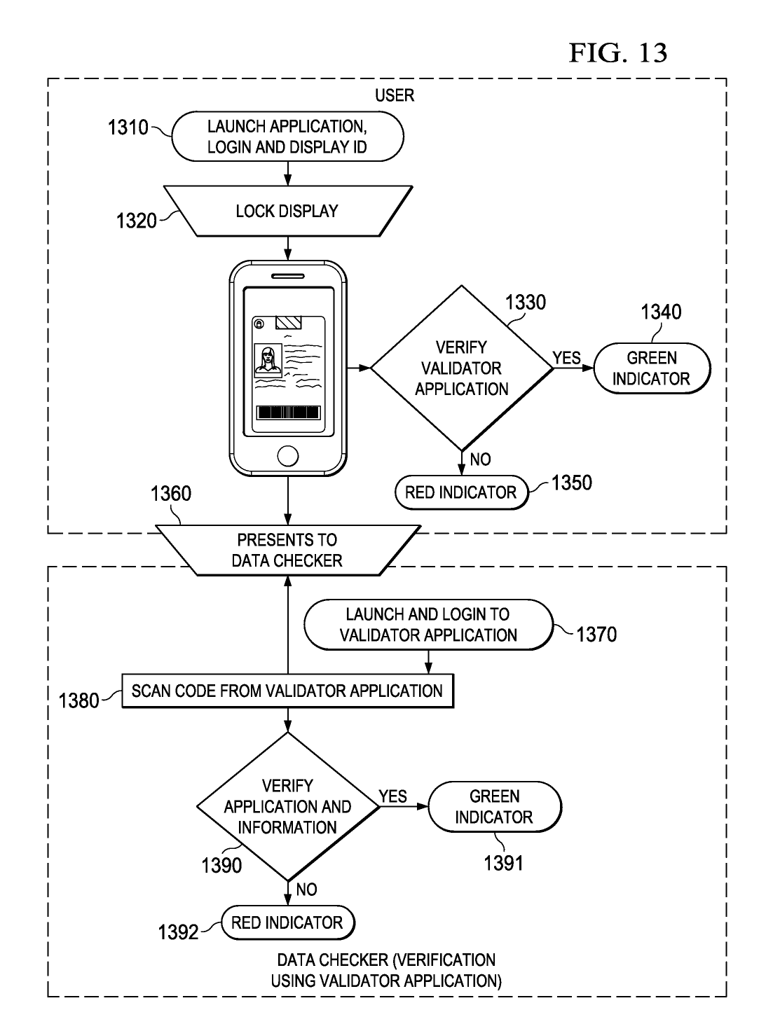

FIG. 13 shows a method for verification of the digital identification by a data checker. The method comprises launching 1310 the digital identification application on the mobile device 110. The user may select an option to lock 1320 the display of the mobile device 110, or the mobile device 110 may automatically lock the display upon presenting the digital identification. The user may select 1330 an option to verify the digital identification. If the digital identification is verified based on accessing information stored in the database 130, an indicator (e.g., a green indicator) is presented 1340 on the digital identification. If the digital identification is unverifiable (e.g., the database 130 is unreachable by the system 120, or the database 130 indicates that there is no match between the user data comprised in the system 120 and data associated with a user record accessed from the database 130), then an appropriate indicator (e.g., a red indicator) is presented 1350 on the digital identification.

Additionally or alternatively, the system 120 checks whether the digital identification application being executed on the mobile device 110 is a verified copy of the digital identification application (e.g., based on application-specific data transmitted from the mobile device 110 to the system 120 either before, with, or after transmission of the authentication credential). If the copy of the application is a verified copy, an appropriate indicator is presented 1340 (e.g., a green indicator). If the copy of the application is not a verified copy or if the copy of the application cannot be verified 1350 (e.g., because application-specific data is not transmitted to the system 120), then an appropriate indicator is presented (e.g., a red indicator).

In some embodiments, the user may present 1360 the digital identification to the data checker. The digital identification comprises a code. A data checker may launch 1370 a validator application on a mobile device (e.g., the data checker's mobile device which is different from the user's mobile device 110). The data checker may use the validator application to scan 1380 the code. By scanning the code, the data checker may access a copy of the digital identification on the data checker's mobile device, or may access user data associated with the digital identification on the data checker's mobile device. At block 1390, the data checker may transmit information associated with the scanned code to the system 120 described herein. The system 120 may locate user data associated with the scanned code, and verify 1390 the user data by accessing the database 130 and comparing the user data to data associated with a user record in the database 130. If there is a match, the system 120 communicates to the data checker's mobile device that the scanned information is associated with a user whose identity is verified. If a match is found, an appropriate indicator (e.g., a green indicator) is presented 1391 (e.g., on the digital identification). If a match is not found, an appropriate indicator (e.g., a red indicator) is presented 1392 (e.g., on the digital identification).

The scanned code may also comprise data associated with a copy of the digital identification application being executed on the user's mobile device 110 or the validator application being executed on the data checker's mobile device. The system 120 may determine 1390 whether the application is a verified application (and not a compromised application or pirated application). If the system 120 determines the application is verified, an appropriate indicator (e.g., a green indicator) is presented 1391 (e.g., on the digital identification). If the system 120 determines the application is not valid or verified, an appropriate indicator (e.g., a red indicator) is presented 1392 (e.g., on the digital identification).

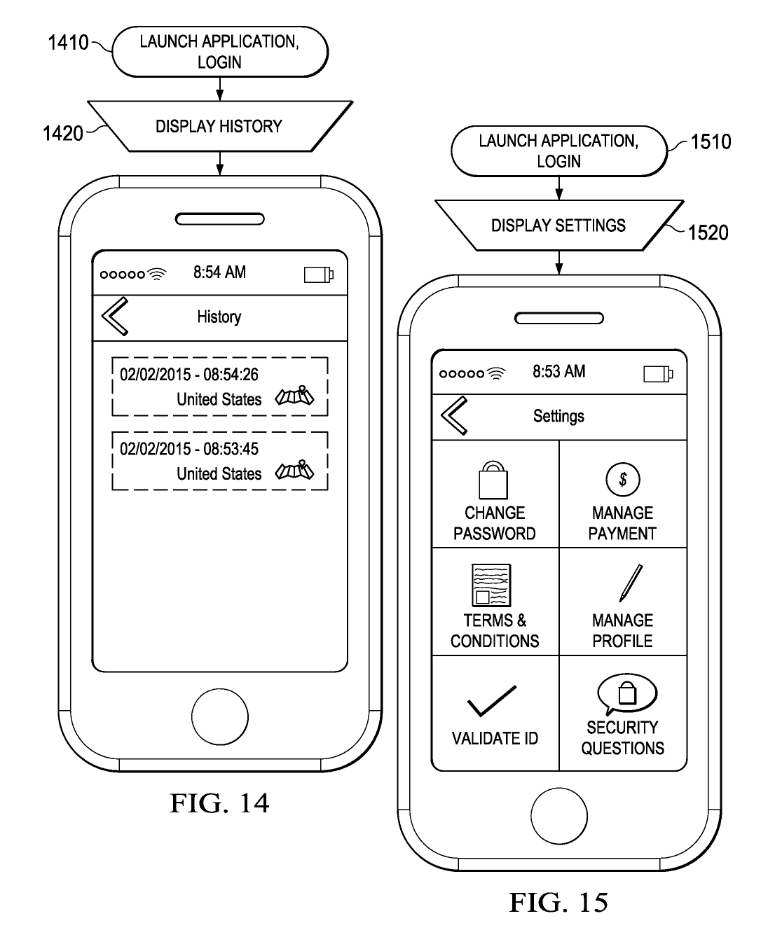

FIG. 14 shows a method for displaying a history of access instances associated with the digital identification. At block 1410, the method comprises launching the digital identification application on the mobile device 110. At block 1420, the method comprises selecting an option to display history of access instances.

FIG. 15 shows a method for displaying settings associated with the digital identification application. At block 1510, the method comprises launching the digital identification application on the mobile device 110. At block 1520, the method comprises selecting an option to display settings associated with the application. Settings include options to change password for the application, manage payment, terms and conditions, manage a user profile, validate (or verify) the digital identification, and security questions. Verifying the digital identification includes a request transmitted from the mobile device 110 to the system 120 such that the system 120 checks, in real-time, whether the user data stored in the system 120 matches data associated with a user record pulled from the database 130.

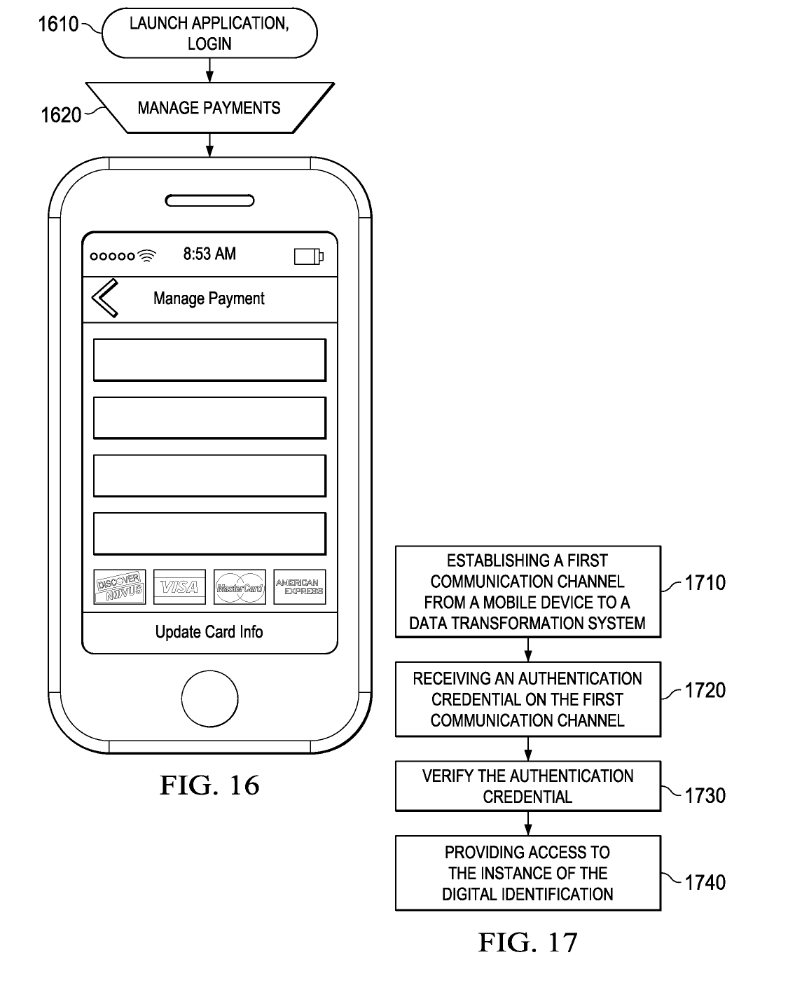

FIG. 16 shows a method for managing payment cards associated with a mobile wallet. The mobile wallet may be integrated into the digital identification application. At block 1610, the method comprises launching the digital identification application on the mobile device 110. At block 1620, the method comprises selecting an option to display payment cards associated with the application. The user may select one or more payment cards previously stored at the mobile device 110 or the system 120 or may enter information (e.g., card number, cardholder name, card expiration date, card code, etc.) associated with a card not previously stored at the mobile device 110 or the system 120. In some embodiments, the access of a mobile wallet application (e.g., comprising one or more payment cards) may be enabled if a user successfully accesses a verified instance of the user's digital identification. Additionally or alternatively, the access of a particular payment card (e.g., in the mobile wallet application or any other payment application) may be enabled if a user successfully accesses either the same or another verified instance of the user's digital identification. In some embodiments, a payment transaction associated with a mobile application is secured based on a user's access of a verified instance of the user's digital identification on the user's mobile device.

FIG. 17 shows a method for providing access to an instance of a digital identification. At block 1710, the method comprises establishing a first communication channel from a mobile device to a data transformation system (e.g., system 120). At block 1720, the method comprises receiving an authentication credential on the first communication channel. At block 1730, the method comprises verifying the authentication credential. At block 1740, the method comprises providing access to the instance of the digital identification.

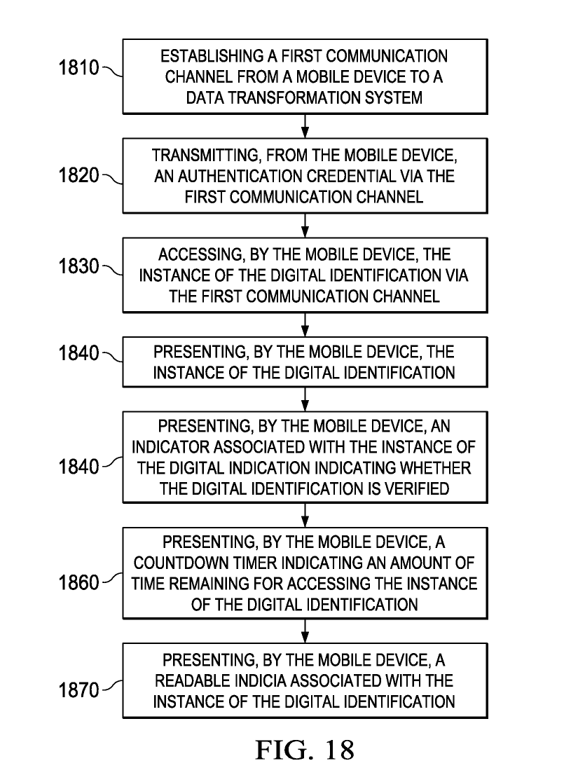

FIG. 18 shows a method for presenting an instance of a digital identification on a mobile device. At block 1810, the method comprises establishing a first communication channel from a mobile device to a data transformation system. At block 1820, the method comprises transmitting, from the mobile device, an authentication credential via the first communication channel. At block 1830, the method comprises accessing, by the mobile device, the instance of the digital identification via the first communication channel. At block 1840, the method comprises presenting, by the mobile device, the instance of the digital identification. At block 1850, the method comprises presenting, by the mobile device, an indicator associated with the instance of the digital indication indicating whether the instance of the digital identification is verified. At block 1860, the method comprises presenting, by the mobile device, a countdown timer indicating an amount of time remaining for accessing the instance of the digital identification. At block 1870, the method comprises presenting, by the mobile device, a readable indicia (e.g., a code) associated with the instance of the digital identification.

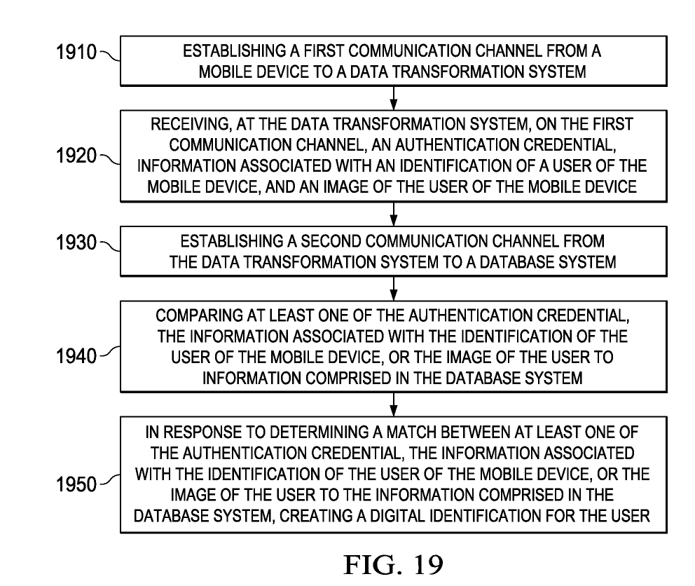

FIG. 19 shows a method for creating a digital identification for a user. At block 1910, the method comprises establishing a first communication channel from a mobile device to a data transformation system. At block 1920, the method comprises receiving, at the data transformation system, on the first communication channel, an authentication credential, information associated with an identification of a user of the mobile device, and an image of the user of the mobile device. At block 1930, the method comprises establishing a second communication channel from the data transformation system to a database system (e.g., database 130). At block 1940, the method comprises comparing at least one of the authentication credential, the information associated with the identification of the user of the mobile device, or the image of the user to information comprised in the database system. At block 1950, the method comprises in response to determining a match between at least one of the authentication credential, the information associated with the identification of the user of the mobile device, or the image of the user to the information comprised in the database system, creating a digital identification for the user.

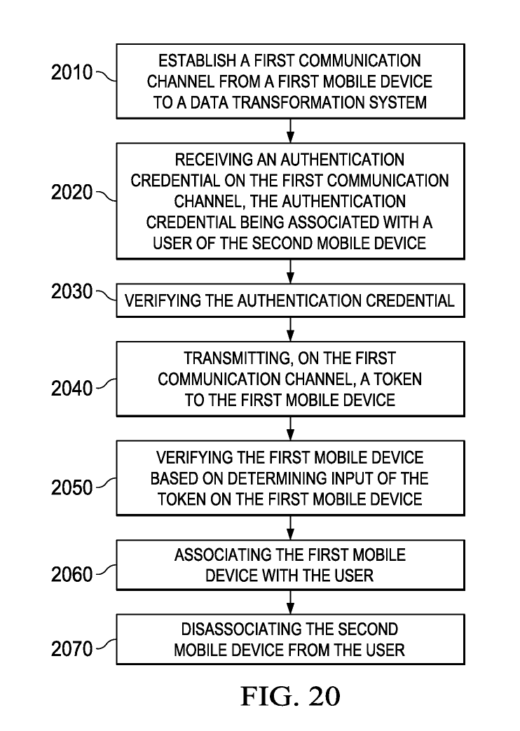

FIG. 20 shows a method for associating a new mobile device with a digital identification. At block 2010, the method comprises establishing a first communication channel from a first mobile device to a data transformation system. At block 2020, the method comprises receiving an authentication credential on the first communication channel, the authentication credential being associated with a user of the second mobile device. At block 2030, the method comprises verifying the authentication credential. At block 2040, the method comprises transmitting, on the first communication channel, a token to the first mobile device. At block 2050, the method comprises verifying the first mobile device based on determining input of the token on the first mobile device. At block 2060, the method comprises associating the first mobile device with the user. At block 2070, the method comprises disassociating the second mobile device from the user.

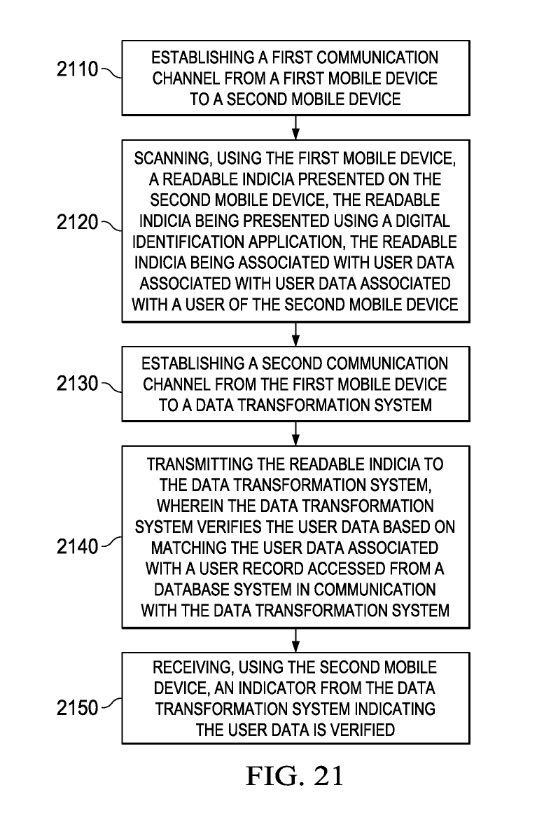

FIG. 21 shows a method for using a first mobile device to determine whether a digital identification presented on a second mobile device is verified. At block 2110, the method comprises establishing a first communication channel from a first mobile device to a second mobile device. At block 2120, the method comprises scanning, using the first mobile device, a readable indicia presented on the second mobile device, the readable indicia being presented using a digital identification application, the readable indicia being associated with user data associated with a user of the second mobile device. At block 2130, the method comprises establishing a second communication channel from the first mobile device to a data transformation system. At block 2140, the method comprises transmitting the readable indicia to the data transformation system, wherein the data transformation system verifies the user data based on matching the user data with data associated with a user record accessed from a database system in communication with the data transformation system. At block 2150, the method comprises receiving, using the second mobile device, an indicator from the data transformation system indicating the user data is verified. In some embodiments, any of the data transmissions from a transmitting device or system may be encrypted such that the receiving device or system may need to decrypt the received data in order to process the received data. The decryption may be executed using a key transmitted separately from the transmitting device or system to the receiving device or system, either before or after the data transmissions.

While various implementations in accordance with the disclosed principles have been described above, it should be understood that they have been presented by way of example only, and are not limiting. Thus, the breadth and scope of the implementations should not be limited by any of the above-described exemplary implementations, but should be defined only in accordance with the claims and their equivalents issuing from this disclosure. Furthermore, the above advantages and features are provided in described implementations, but shall not limit the application of such issued claims to processes and structures accomplishing any or all of the above advantages.

Various terms used herein have special meanings within the present technical field. Whether a particular term should be construed as such a “term of art,” depends on the context in which that term is used. “Connected to,” “in communication with,” “communicably linked to,” “in communicable range of” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under 37 C.F.R. 1.77 or otherwise to provide organizational cues. These headings shall not limit or characterize the implementations set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any implementations in this disclosure. Neither is the “Summary” to be considered as a characterization of the implementations set forth in issued claims. Furthermore, any reference in this disclosure to “implementation” in the singular should not be used to argue that there is only a single point of novelty in this disclosure. Multiple implementations may be set forth according to the limitations of the multiple claims issuing from this disclosure, and such claims accordingly define the implementations, and their equivalents, that are protected thereby. In all instances, the scope of such claims shall be considered on their own merits in light of this disclosure, but should not be constrained by the headings herein.

What is claimed is:

1. A method for verifying access of an instance of a digital identification, the method comprising:
establishing a first communication channel from a mobile device to a data transformation system;
receiving an authentication credential on the first communication channel;
verifying the authentication credential; and
providing access to the instance of the digital identification,
wherein, in response to verifying the authentication credential, the mobile device accesses: the instance of the digital identification, an indicator associated with the instance of the digital identification indicating the instance of the digital identification is verified based on communication with a database system, a countdown timer indicating an amount of time remaining for accessing the instance of the digital identification, and a readable indicia associated with accessing the instance of the digital identification.

2. The method of claim 1, further comprising
in response to verifying the authentication credential, generating a verification request;
establishing a second communication channel from the data transformation system to the database system; and
verifying the verification request based on communicating with the database system.

3. The method of claim 2, wherein the verification request comprises user information stored in the data transformation system.

4. The method of claim 2, wherein the verification request comprises verification data generated by the data transformation system.

5. The method of claim 2, wherein verifying the verification request comprises determining whether user information comprised in the verification request matches user information comprised in a user record in the database system.

6. The method of claim 2, wherein the authentication credential and the verification request are verified in real-time.

7. The method of claim 1, wherein the authentication credential comprises device authentication data associated with the mobile device and user authentication data associated with a user of the mobile device.

8. The method of claim 7, wherein the user authentication data comprises biometric data associated with the user.

9. A method for accessing an instance of a digital identification, the method comprising:
establishing a first communication channel from a mobile device to a data transformation system;
transmitting, from the mobile device, an authentication credential via the first communication channel;
accessing, by the mobile device, the instance of the digital identification via the first communication channel;
presenting, by the mobile device, the instance of the digital identification;
presenting, by the mobile device, an indicator associated with the instance of the digital indication indicating whether the instance of the digital identification is verified;
presenting, by the mobile device, a countdown timer indicating an amount of time remaining for accessing the instance of the digital identification; and
presenting, by the mobile device, a readable indicia associated with the instance of the digital identification.

10. The method of claim 9, further comprising locking a display of the mobile device, the locking the display of the mobile device disabling manipulation of the instance of the digital identification.

11. The method of claim 9, further comprising presenting an airline ticket or boarding pass integrated with the instance of the digital identification.

12. The method of claim 9, further comprising presenting a history of access instances of the digital identification.

13. The method of claim 9, further comprising associating the digital identification with a payment card associated with a mobile wallet or a payment transaction executed on the mobile device.

14. A method for registering a digital identification, the method comprising:
establishing a first communication channel from a mobile device to a data transformation system;
receiving, at the data transformation system, on the first communication channel, an authentication credential, information associated with an identification of a user of the mobile device, and an image of the user of the mobile device;
establishing a second communication channel from the data transformation system to a database system;
comparing at least one of the authentication credential, the information associated with the identification of the user of the mobile device, or the image of the user to information comprised in the database system; and
in response to determining a match between at least one of the authentication credential, the information associated with the identification of the user of the mobile device, or the image of the user to the information comprised in the database system, creating the digital identification for the user.

15. The method of claim 14, wherein establishing the second communication channel comprises searching, at the database system, for a user record associated with the user of the mobile device, and wherein the information comprised in the database system comprises the user record.

16. The method of claim 14, wherein establishing the second communication channel comprises receiving the information comprised in the database system.

17. The method of claim 14, wherein the authentication credential comprises device authentication data associated with the mobile device or user authentication data associated with the user.

18. The method of claim 14, wherein the authentication credential comprises a credential previously transmitted from the data transformation system to the user.

19. The method of claim 14, wherein the digital identification is accessible on the mobile device, and is inaccessible on a different mobile device.

20. A method for associating a mobile device with a user, the method comprising:
establishing a first communication channel from a first mobile device to a data transformation system;
receiving an authentication credential on the first communication channel, the authentication credential being associated with a user of the second mobile device;
verifying the authentication credential;
transmitting, on the first communication channel, a token to the first mobile device;
verifying the first mobile device based on determining input of the token on the first mobile device;
associating the first mobile device with the user; and
disassociating the second mobile device from the user.

21. A method for verifying a digital identification presented on a mobile device, the method comprising:
establishing a first communication channel from a first mobile device to a second mobile device;
scanning, using the first mobile device, a readable indicia presented on the second mobile device, the readable indicia being presented using a digital identification application, the readable indicia being associated with user data associated with a user of the second mobile device;
establishing a second communication channel from the first mobile device to a data transformation system;
transmitting the readable indicia to the data transformation system, wherein the data transformation system verifies the user data based on matching the user data with data associated with a user record accessed from a database system in communication with the data transformation system; and
receiving, using the second mobile device, an indicator from the data transformation system indicating the user data is verified.
